(19) United States
(12) Patent Application Publication
(10) Pub. No.: US 2025/0045572 A1
(43) Pub. Date: Feb. 6, 2025

(54) QUANTIZATION FOR NEURAL NETWORKS

(71) Applicant: TEXAS INSTRUMENTS INCORPORATED, Dallas, TX (US)

(72) Inventors: Varun Tripathi, Gurgaon (IN); Manu Mathew, Bangalore (IN); Pramod Swami, Bangalore (IN); Kumar Desappan, Bangalore (IN)

(21) Appl. No.: 18/408,351

(22) Filed: Jan. 9, 2024

(30) Foreign Application Priority Data
Aug. 4, 2023 (IN) 202341052481

(51) Int. Cl. G06N 3/0495

(52) U.S. Cl. CPC G06N 3/0495

(57) ABSTRACT

Disclosed herein are systems and methods for performing post training quantization. A processor obtains fixed-point output values from a layer of an artificial neural network (ANN) wherein the layer includes fixed-point weights determined based on floating-point weights and a weight scaling factor determined based on an output scaling factor. Next, the processor converts the fixed-point output values to floating-point output values based on the output scaling factor. Then, the processor expands a range of floating-point values. Next, the processor calculates a new output scaling factor based on the expanded range of floating-point output values. Finally, the processor stores the new output scaling factor in an associated memory.

### RELATED APPLICATIONS

This application is related to, and claims the benefit of priority to, India Provisional Patent Application No. 202341052481, filed on Aug. 4, 2023, and entitled “Methods to Improve Accuracy of Neural Networks with Fixed Point Hardware”, which is hereby incorporated by reference in its entirety.

### TECHNICAL FIELD

Aspects of the disclosure are related to the field of computing hardware and software and more particularly to quantizing floating-point values of neural networks.

### BACKGROUND

Quantization describes a process of constraining a continuous, or an otherwise large set of values, to a discrete set. For example, the 32-bit weight values employed by the nodes of a floating-point deep neural network (DNN) may be quantized to an 8-bit precision. Advantageously, quantizing floating-point weight values of a DNN to fixed-point numbers allows the operations of the DNN to be accelerated via fixed-point hardware accelerators.

Traditionally, floating-point DNNs are quantized asymmetrically. Asymmetric quantization describes a non-linear mapping process which distributes the weight values of a DNN non-uniformly across a determined zero point. In the machine learning context, asymmetric quantization is the preferred method of quantization as it allows for a better representation of the values relevant to the DNN.

Unfortunately, traditional methods to quantize floating-point DNNs are prone to various errors such as quantization error and clipping error. Quantization error describes the difference between floating-point values and their fixed-point representations. The goal of quantization is to reduce the quantization error so that the difference between a floating-point value and its fixed-point representation is minimized. Consequently, accounting for quantization error can lead to the clipping of extreme values (i.e., clipping error). As a result, quantization methods which introduce quantization error and in turn clipping error lead to accuracy degradation of the DNN.

### SUMMARY

Technology is disclosed herein that improves the accuracy of neural networks employed on fixed-point hardware. Various implementations include a computer implemented method for performing post training quantization. Processing circuitry of a suitable computing system obtains fixed-point output values from a layer of an artificial neural network (ANN) wherein the layer includes fixed-point weights and a weight scaling factor. The fixed-point weights are determined based on floating-point weights while the weight scaling factor is determined based on an output scaling factor. Next, the processing circuitry converts the fixed-point output values to floating-point output values based on the output scaling factor. Then, the processing circuitry expands a range of floating-point output values. Next, the processing circuitry calculates a new output scaling factor based on the expanded range of floating-point output values. Finally, the processing circuitry stores the new output scaling factor in a memory associated with the suitable computing system.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a quantization architecture in an implementation.

FIG. 2 illustrates a quantization method in an implementation.

FIG. 3 illustrates another quantization architecture in an implementation.

FIG. 4 illustrates an operational sequence in an implementation.

FIG. 5 illustrates a post training quantization process in an implementation.

FIG. 6 illustrates a scale process in an implementation.

FIG. 7 illustrates a saturation process in an implementation.

FIG. 8 illustrates a results table in an implementation.

FIG. 9 illustrates another results table in an implementation.

FIG. 10 illustrates a computing system suitable for implementing the various operational environments, architectures, processes, scenarios, and sequences discussed below with respect to the other Figures.

### DETAILED DESCRIPTION

Technology is disclosed herein that provides a quantization method which can potentially improve the accuracy of neural networks employed via fixed-point hardware. Generally speaking, deep neural networks (DNNs) are trained to perform a designated task with floating-point values. For example, such tasks may include object detection, voice recognition, image processing, language modelling, and so on. As a result, the weight values employed by the nodes of the trained DNN are representative of floating-point numbers.

In some implementations, floating-point weights of a DNN are quantized to fixed-point values via a process called post training quantization (PTQ). The goal of the PTQ process is to quantize the weight values of a DNN to a desired bit precision while maintaining the accuracy of the neural network. The purpose of the PTQ process is to allow the operations of a DNN to be accelerated via fixed-point hardware accelerators.

Disclosed herein are methods to perform post training quantization which can potentially improve the accuracy, scaling, latency, bandwidth, and power characteristics of DNNs. In an implementation, the disclosed PTQ process is representative of an iterative cycle of two subprocesses. The first subprocess is representative of scaling process which describes the method in which the floating-point weight values of a DNN are quantized to fixed-point numbers. The second subprocess is representative of a saturation process which describes the method in which various errors are accounted for. In an implementation, a processor iteratively cycles through the scaling and saturation processes until a number of calibration iterations has been reached. Once reached, the processor embeds the DNN with the fixed-point weights determined via the scaling and saturation processes.

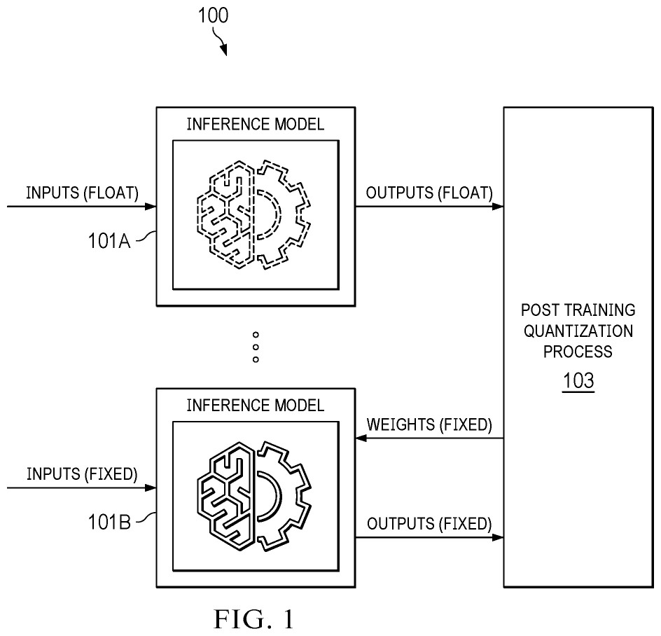

Turning now to the figures, FIG. 1 illustrates quantization architecture 100 in an implementation. Quantization architecture 100 is representative of an exemplary software architecture for quantizing floating-point neural networks. Quantization architecture 100 may be implemented in the context of program instructions, executable by a suitable computing system. For example, such computing systems may include microcontrollers, digital signal processors, application specific integrated circuits, central processing units, graphics processing units, field-programmable gate arrays, and/or any other processing resources. Quantization architecture 100 includes, but is not limited to, floating-point inference model 101A, fixed-point inference model 101B, and post training quantization (PTQ) process 103.

Floating-point inference model 101A is representative of neural network which performs operations with floating-point weights. For example, floating-point inference model 101A may be representative of a convolutional neural network (CNN), artificial neural network (ANN), or another deep neural network (DNN) of the like. In an implementation, floating-point inference model 101A is iteratively trained with floating-point data to perform a task. For example, such tasks may include classification, sequence learning, or function approximation.

Fixed-point inference model 101B is the fixed-point representation of floating-point inference model 101A. As such, fixed-point inference model 101B is representative of a neural network which performs the same operations as floating-point inference model 101A, but instead with fixed-point weights. In an implementation, fixed-point inference model 101B offloads fixed-point computations to a hardware accelerator configured to perform the operations of fixed-point inference model 101B.

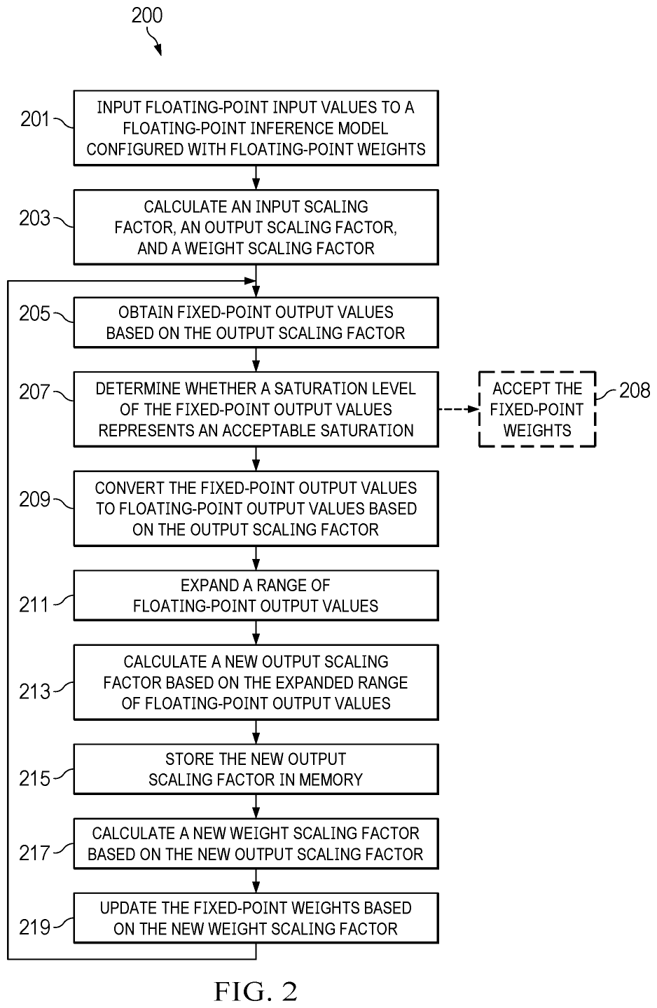

Post training quantization process 103 is representative of software which quantizes the weight values of a neural network while maintaining the network's accuracy. For example, PTQ process 103 may be executed to convert floating-point weights of floating-point inference model 101A to fixed-point values. In another example, PTQ process 103 may be executed to improve the accuracy of fixed-point inference model 101B. In an implementation, PTQ process 103 is representative of program instructions, that when executed by suitable processing circuitry, direct the processing circuitry to perform in accordance with the steps of PTQ process 103, later discussed in FIG. 2.

In a brief operational scenario, PTQ process 103 may be executed to convert floating point inference model 101A to fixed-point inference model 101B. To begin, floating-point inference model 101A receives floating-point input data representative of image data, video data, audio data, language/text data, or a combination thereof. In response, floating-point inference model 101A generates floating-point output data, which is supplied to PTQ process 103. PTQ process 103 utilizes the floating-point data (inputs, outputs, and weights) of floating-point inference model 101A to generate a first set of fixed-point weights.

Next, PTQ process 103 loads the first set of fixed-point weights to fixed-point inference model 101B. Once accepted by the layers of the network, fixed-point inference model 101B receives fixed-point input data and generates a first set of fixed-point output data. Fixed-point inference model 101B supplies the first set of fixed-point output data to PTQ process 103. PTQ process 103 analyzes the accuracy of the first set of-fixed point output data and in response adjusts the first set of fixed-point weights to generate a second set of fixed-point weights. PTQ process 103 loads the second set of fixed-point weights to fixed-point inference model 101B which generates a second set of fixed-point output data. In an implementation, PTQ process 103 continues to adjust the subsequent sets of fixed-point weights until the output data of fixed-point inference model 101B satisfies an accuracy threshold.

FIG. 2 illustrates quantization method 200 in an implementation. Quantization method 200 is representative of software that quantizes the weight values of a neural network while preserving the accuracy of the network. For example, quantization method 200 may be representative of PTQ process 103 of FIG. 1. Quantization method 200 may be implemented in the context of program instructions that, when executed by a suitable computing system, direct the processing circuitry of the computing system to operate as follows, referring parenthetically to the steps in FIG. 2. In some examples, quantization method 200 may include additional operations and/or fewer than all of the operations shown in FIG. 2.

To begin, the processing circuitry inputs floating-point input values to a floating-point inference model configured with floating-point weights (step 201). For example, the processing circuitry may supply the floating-point input values to floating-point inference model 101A. The floating-point input values supplied to the floating-point inference model are representative of data collected by a source. For example, input data may be representative of image data, video data, or audio data collected by a respective sensor, or language/text data received as input. The floating-point inference model receives the floating-point input data and in response generates floating-point output data to be supplied to the processing circuitry. In an implementation, the floating-point inference model provides the floating-point input data, output data, and weight data to the processing circuitry.

Next the processing circuitry calculates an input scaling factor, an output scaling factor, and a weight scaling factor based on the received floating-point data (step 203). The input scaling factor, output scaling factor, and weight scaling factor are representative of scales for quantizing respective floating-point data. For example, the input scaling factor may be used to quantize floating-point input data, the output scaling factor may be used to quantize floating-point output data, and the weight scaling factor may be used to quantize floating-point weights.

In an implementation, to determine the input scaling factor, output scaling factor, and weight scaling factor, the processing circuitry first determines the total number of fixed-point values that may be used to represent fixed-point data. For example, if an associated hardware accelerator performs operations with signed 8-bit data (i.e., −128 to 127), then the total number of values allowed to represent fixed-point data (e.g., input data, output data, or weight data) is equal to 256. Next, to determine the input scaling factor, the processing circuitry divides the allowable number of fixed-point values by a range of floating-point input values. The range of floating-point input values describes the difference between the maximum floating-point input value and the minimum floating-point input value. Similarly, to determine the output scaling factor, the processing circuitry divides the allowable number of fixed-point values by a range of floating-point output values. The range of floating-point output values describes the difference between the maximum floating-point output value and the minimum floating-point output value. Additionally or alternatively, to calculate the weight scaling factor the processing circuitry divides the allowable number of fixed-point values by the absolute maximum floating-point weight value.

After the processing circuitry calculates the scaling factors for the floating-point data, the processing circuitry obtains fixed-point output values based on the current output scaling factor (step 205). For example, the processing circuitry may scale the received floating-point output data with the current output scaling factor to obtain the fixed-point output values. In another example, to obtain the fixed-point output values, the processing circuitry first scales the floating-point weights to fixed-point values via the current weight scaling factor. Next, the processing circuitry supplies the fixed-points weights to a fixed-point inference model. For example, the processing circuitry may supply the fixed-point weights to fixed-point inference model 101B. Once the fixed-point weights are accepted by the layers of the fixed-point inference model, the processing circuitry inputs fixed-point input values to the fixed-point inference model. In an implementation, the fixed-point input values are generated by the processing circuitry by scaling the floating-point input values with the input scaling factor. In response to receiving the fixed-point input values, the fixed-point inference model generates the fixed-point output values.

Next, the processing circuitry determines whether a saturation level of the fixed-point output values represents an acceptable saturation (step 207). The saturation level of the fixed-point output values describes the number of fixed-point output values which are represented by the extremes of the allowable fixed-point range. For example, if the employed date-type is representative of signed 8-bit data, then the saturation level describes the number of fixed-point output values represented by −128 or 127. In another example, when the employed data type is representative of unsigned 8-bit data, then the saturation level describes the number of fixed-point output values represented by either 0 or 255.

In an implementation, if the processing circuitry determines that less than (or equal to) a threshold level/number/percentage (e.g., 1%) of the fixed-point output values are saturated, then the processing circuitry accepts the current fixed-point weights (step 208). The processing circuitry may accept the current fixed-point weights by embedding the weights into the layers of the fixed-point inference model.

Alternatively, if the processing circuitry determines that more than the threshold/level/number/percentage (e.g., 1%) of the fixed-point output values are saturated, then the processing circuitry converts the fixed-point output values to floating-point output values based on the current output scaling factor (step 209). As a result, the floating-point output values produced by the processing circuitry are representative of a second set of floating-point output values.

After generating the second set of floating-point output values, the processing circuitry expands the range of the second set based on the direction of the saturation (step 211). For example, if the fixed-point output values were saturated on the high-end of the allowable fixed-point range (e.g., 127 or 255), then the processing circuitry increases the maximum value represented by the second set of floating-point output values by a threshold amount. In an implementation, the processing circuitry increases the maximum floating-point output value by a factor of 2%. Alternatively, if the fixed-point output values were saturated on the low-end of the allowable fixed-point range (e.g., −128 or 0), then the processing circuitry decreases the minimum value represented by the second set of floating-point output values by the threshold amount (e.g., 2%).

Next, the processing circuitry calculates a new output scaling factor based on the expanded range of the second set of floating-point output values (step 213). In an implementation, to calculate the new output scaling factor, the processing circuitry divides the allowable number of fixed-point values by the expanded range of the second set of floating-point output values. After calculating the new output scaling factor, the processing circuitry stores the new output scaling factor in an associated memory (step 215).

Next, the processing circuitry calculates a new weight scaling factor based on the new output scaling factor (step 217). The processing circuitry may store the new weight scaling factor to the memory. Once the new weight scaling factor is calculated, the processing circuitry updates the fixed-point weights based on the new weight scaling factor (step 219) and returns to step 205. In an implementation, the processing circuitry iteratively cycles through quantization process 200 until the floating-point output data represents an acceptable saturation. In another implementation, the processing circuitry iteratively cycles through quantization process 200 until a maximum number of calibration iterations has been reached.

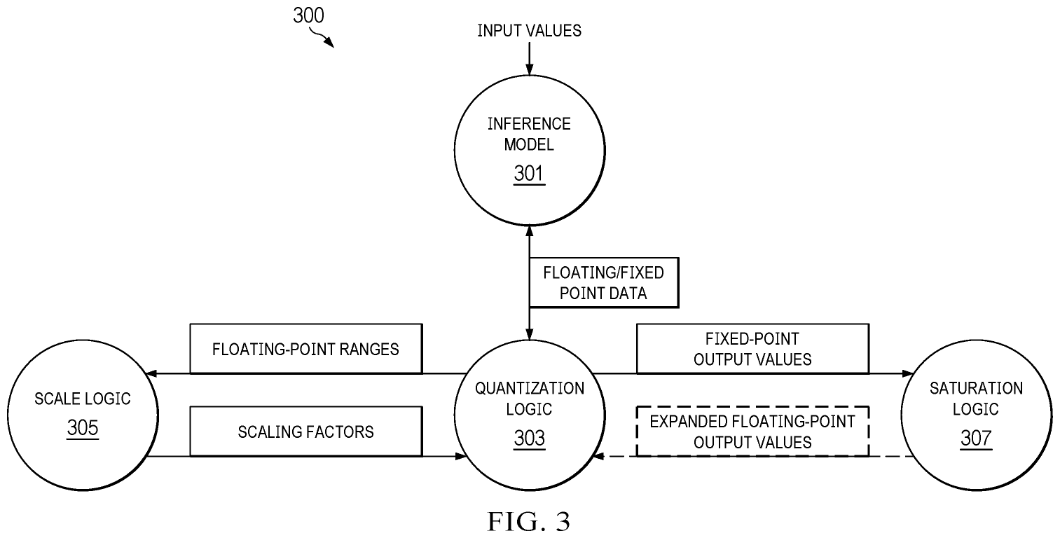

FIG. 3 illustrates quantization architecture 300 in an implementation. Quantization architecture 300 is representative of an exemplary software architecture which quantizes floating-point data of a neural network while preserving the network's accuracy. For example, quantization architecture 300 may be representative of quantization architecture 100 of FIG. 1. Quantization architecture 300 may be implemented in the context of program instructions, executable by a suitable computing system. For example, such computing systems may include microcontrollers, digital signal processors, application specific integrated circuits, central processing units, graphics processing units, field-programmable gate arrays, and/or any other processing resources. Quantization architecture 300 includes, but is not limited to, inference model 301, quantization logic 303, scale logic 305, and saturation logic 307.

Inference model 301 is representative of a neural network which has been trained to perform a task. For example, inference model 301 may be representative of an ANN, a CNN, or another DNN of the like trained to perform tasks such as object detection, image classification, speech recognition, and so on. In an implementation, inference model 301 is trained with floating-point data. As a result, the weight values employed by the layers of inference model 301 are representative of floating-point values. In an implementation, the floating-point weights of inference model 301 are quantized via quantization logic 303, scale logic 305, and saturation logic 307 to allow the operations of inference model 301 to be performed by a hardware accelerator. Advantageously, outsourcing operations of inference model 301 to an associated hardware accelerator decreases the processing times required to perform a task.

Quantization logic 303 is representative of a software block which performs the method of post training quantization disclosed herein. For example, quantization logic 303 may be representative of PTQ process 103 or quantization method 200. Quantization logic 303 receives data from inference model 301 to generate fixed-point weights for the layers of inference model 301. In an implementation, quantization logic 303 interfaces with scale logic 305 and saturation logic 307 to generate fixed-point weights which preserve the accuracy of inference model 301.

Scale logic 305 is representative of a software block which determines the scaling factors for quantizing the floating-point data of inference model 301. For example, scale logic 305 may generate scaling factors for the floating-point input values, floating-point output values, and floating-point weights of inference model 301. Scale logic 305 receives floating-point input ranges, output ranges, and weight ranges from quantization logic 303. In response, scale logic 305 calculates the respective input scaling factors, output scaling factors, and weight scaling factors for the floating-point data of inference model 301.

Saturation logic 307 is representative of a software block which monitors the saturation level of the fixed-point output values produced by inference model 301. The saturation level of the fixed-point output values describes the number of values represented by the low-or high-ends of the allowable fixed-point range. For example, if the associated hardware accelerator performs computations with signed 8-bit data, then the saturation level describes the amount of fixed-point output values represented by −127 or +128. In an implementation, if the saturation level of the fixed-point output values does not represent an acceptable saturation, then saturation logic 307 expands the range of floating-point output values and scale logic 305 generates new scaling factors based on the expanded range. Alternatively, if the saturation level of the fixed-point output values represents the acceptable saturation, then quantization logic 303 embeds the fixed-point weights (associated with the acceptable saturation) into inference model 301.

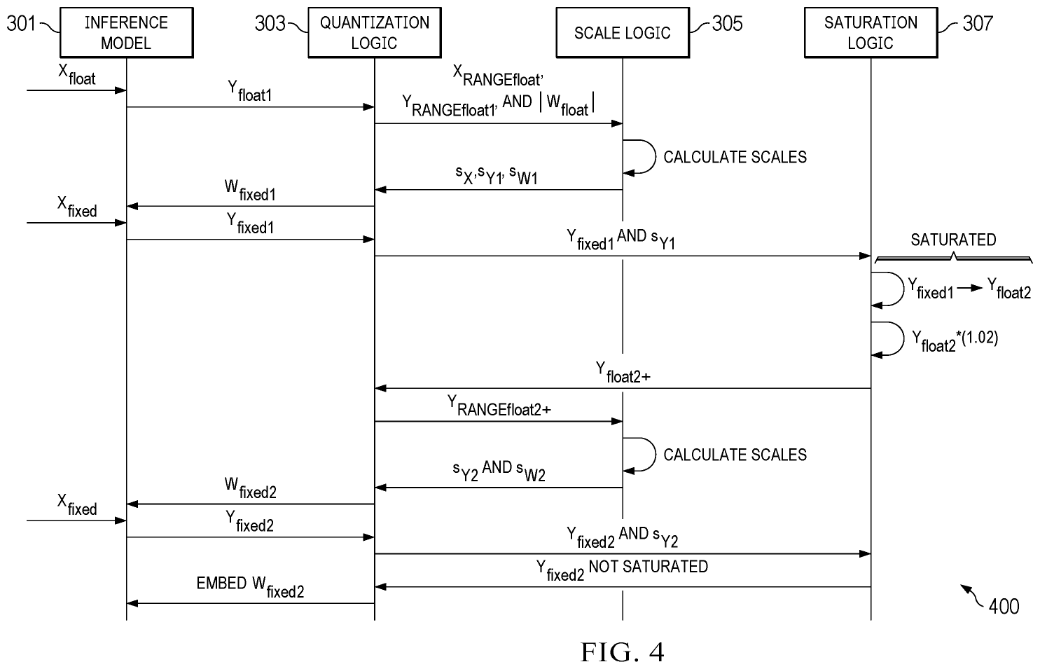

FIG. 4 illustrates operational sequence 400 in an implementation. Operational sequence 400 represents the sequence of operations performed by quantization architecture 300. To begin, inference model 301 receives floating-point input values (X_{float}) representative of image data, video data, audio data, language/text data, or a combination thereof. Next, inference model 301 generates a first set of floating-point output values (Y_{float1}) based on the received floating-point input data. Inference model 301 provides the first set of floating-point output values to quantization logic 303. In an implementation, inference model 301 also provides the floating-point input values and the floating-point weights, used to generate the first set of floating-point output values, to quantization logic 303. In another implementation, quantization logic 303 is preloaded with the floating-point input values and the floating-point weights.

Next, quantization logic 303 determines the floating-point input range (X_{RANGEfloat}), the first floating-point output range (Y_{RANGEfloat1}), and the absolute maximum floating-point weight value (|W_{float}|) of inference model 301. In an implementation, to determine the floating-point input and output ranges, quantization logic 303 determines the difference between a maximum floating-point value and a minimum floating-point value. For example, quantization logic 303 may employ the following equations:

$${X}_{RANGEfloat} = {X}_{MAXfloat} - {X}_{MINfloat} \qquad ( 1 )$$

$${Y}_{RANGEfloat 1} = {Y}_{MAXfloat 1} - {Y}_{MINfloat 1} \qquad ( 2 )$$

Such that in Equation (1), X_{RANGEfloat} represents the floating-point input range, X_{MAXfloat} represents the maximum floating-point input value, and X_{MINfloat} represents the minimum floating-point input value, and such that in Equation (2) Y_{RANGEfloat1} represents the first floating-point output range, Y_{MAXfloat1} represents the maximum value from the first set of floating-point output values, and Y_{MINfloat1} represents the minimum value from the first set of floating-point output values.

Upon determining the floating-point input range, the first floating-point output range, and the absolute maximum floating-point weight value, quantization logic 303 provides the floating-point ranges and absolute maximum floating-point weight value to scale logic 305. In response, scale logic 305 calculates the scaling factors for the floating-point input values, the first set of floating-point output values, and the floating-point weights. In an implementation, to calculate the scaling factors, scale logic 305 first determines the allowable number of fixed-point values that may be used to represent fixed-point data. For example, if an associated hardware accelerator performs computations with 8-bit data, then the total number of values that may be used to represent fixed-point data is equal to 256. Alternatively, if the associated hardware accelerator performs computations with 16-bit data, then the total number of values that may be used to represent fixed-point data is equal to 65,536.

Next, to determine the input scaling factor, scale logic 305 divides the allowable number of fixed-point values by the floating-point input range. For example, scale logic 305 may execute the following equation:

$${s}_{X} = \frac{allowable \# of fixed point values}{{X}_{RANGEfloat}} \qquad ( 3 )$$

Such that in Equation (3), s_{X} represents the input scaling factor and X_{RANGEfloat} represents the floating-point input range.

Similarly, to determine the output scaling factor, scale logic 305 divides the allowable number of fixed-point values by the floating-point output range. For example, scale logic 305 may execute the following equation:

$${s}_{Y 1} = \frac{allowable \# of fixed point values}{{Y}_{RANGEfloat 1}} \qquad ( 4 )$$

Such that in Equation (4), s_{Y1} represents the first output scaling factor and Y_{RANGEfloat1} represents the first floating-point output range.

Additionally or alternatively, to determine the weight scaling factor, scale logic 305 divides the allowable number of fixed-point values by the absolute maximum floating-point weight value. For example, scale logic 305 may execute the following equation:

$${s}_{W 1} = \frac{allowable \# of fixed point values}{\vert {W}_{float} \vert} \qquad ( 5 )$$

Such that in Equation (5), s_{W1} represents the first weight scaling factor and | W_{float}| represents the absolute maximum floating-point weight value.

Scale logic 305 provides the input scaling factor (s_{X}), the first output scaling factor (s_{Y1}), and the first weight scaling factor (s_{W1}) to quantization logic 303. In response, quantization logic 303 utilizes the weight scaling factor to quantize the floating-point weights to a first set of fixed-point weights (W_{fixed1}). Quantization logic 303 provides the first set of fixed-point weights to inference model 301. In an implementation, quantization logic 303 also provides fixed-point input values (X_{fixed}) to inference model 301. For example, quantization logic 303 may utilize the input scaling factor to quantize the floating-point input values to the appropriate fixed-point representation. Alternatively, inference model 301 may receive the fixed-point input values from an external source.

After receiving the necessary fixed-point data, inference model 301 generates a first set of fixed-point output values (Y_{fixed1}) and provides the values to quantization logic 303. In response, quantization logic 303 supplies the first set of fixed-point output values and the first output scaling factor to saturation logic 307.

Next, saturation logic 307 determines if the first set of fixed-point output values satisfies a saturation threshold. In an implementation, saturation logic 307 examines the number of values represented by an extreme of the acceptable fixed-point range to determine if the first set of fixed-point output values satisfies the saturation threshold. For example, if the associated hardware accelerator performs operations with signed 8-bit data, then saturation logic 307 examines the number of values from the first set of fixed-point output values which are represented by either-127 or +128. In an implementation, if more than 1% of the values from the first set of fixed-point output values are represented by an extreme of the acceptable fixed-point range, then saturation logic 307 determines that the first set of fixed-point values do not satisfy the saturation threshold. Else, saturation logic 307 determines that the first set of fixed-point values satisfies the saturation threshold.

In response to determining that the first set of fixed-point output values do not satisfy the saturation threshold, saturation logic 307 converts the first set of fixed-point output values to a second set of floating-point output values (Y_{float2}), based on the first output scaling factor. Next, saturation logic 307 expands the second set of floating-point output values in the direction of the saturation. For example, when the desired data type for performing fixed-point computations is signed 8-bit data, and more than 1% of the values from the first set of fixed-point output values were represented by the maximum value of the allowable fixed-point range (i.e., 128), then saturation logic 307 expands the maximum value represented by the second set of floating-point output values by a factor of 2%. Alternatively, if more than 1% of values from the first set of fixed-point output values were represented by the minimum value of the allowable fixed-point range (i.e., −127), then saturation logic 307 expands the minimum value represented by the second set of floating-point output values by a factor of 2%. A factor of 1.02 is just one example of an expansion factor. Other values may be used for the expansion factor.

Saturation logic 307 provides the second set of expanded floating-point output values (Y_{float2+}) to quantization logic 303. In response, quantization logic 303 calculates the range of the second set of expanded floating-point output values (Y_{RANGEfloat2+}) and provides the range to scale logic 305. Scale logic 305 receives the range of the second set of expanded floating-point output values and responsively determines a second output scaling factor (s_{Y2}) and a second weight scaling factor (s_{W2}). Scale logic 305 provides the second output scaling factor and the second weight scaling factor to quantization logic 303. In response, quantization logic 303 quantizes the floating-point weights based on the second weight scaling factor to generate a second set of fixed-point weights (W_{fixed2}).

Quantization logic 303 provides the second set of fixed-point weights to inference model 301. After receiving the necessary fixed-point data, inference model 301 generates a second set of fixed-point output values (Y_{fixed2}) and provides the values to quantization logic 303. In response, quantization logic 303 supplies the second set of fixed-point output values and the second output scaling factor to saturation logic 307. Next, saturation logic 307 determines that the second set of fixed-point output values satisfies the saturation threshold and responsively informs quantization logic 303 of the determination. Finally, quantization logic 303 embeds the second set of fixed-point weights into the layers of inference model 301.

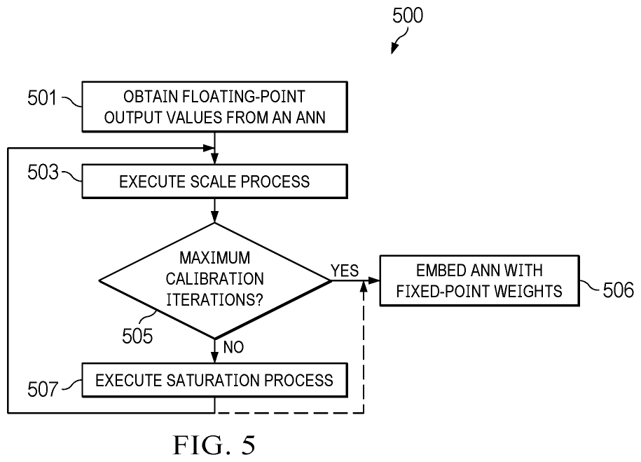

Now turning to the next figure, FIG. 5 illustrates post training quantization process 500 in an implementation. PTQ process 500 is representative of a process for quantizing the floating-point weights of a neural network while maintaining the accuracy of the network. For example, PTQ process 500 may be representative of PTQ process 103, quantization method 200, or quantization logic 303. In an implementation PTQ process 500 is implemented in the context of program instructions that, when executed by a suitable computing system, direct the processing circuitry of the computing system to operate as follows, referring parenthetically to the steps in FIG. 5.

To begin, the processing circuitry obtains floating-point output values from an artificial neural network (step 501). It should be noted that the processing circuitry may obtain floating-point output values from any type of neural network, but for the purposes of explanation, an ANN will be discussed herein. In an implementation, the processing circuitry further obtains floating-point input values and floating-point weights from the ANN.

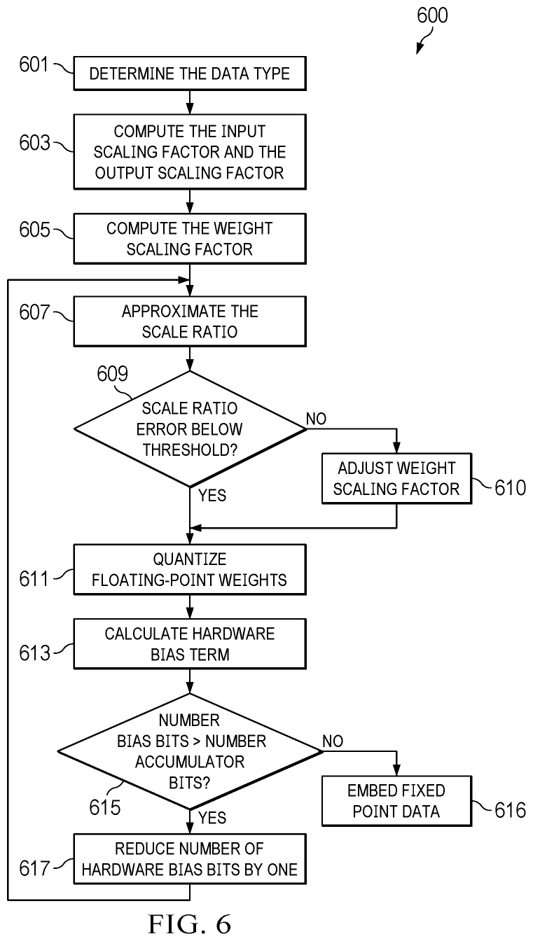

Next, the processing circuitry executes a scale process for determining the scaling factors for the floating-point data of the ANN (step 503). For example, the processing circuitry may execute scale process 600, later discussed with reference to FIG. 6. In an implementation, scale process 600 determines the input scaling factors, output scaling factors, and weight scaling factors for the floating-point data of the ANN. The input scaling factor is representative of scale for quantizing the floating-point input data to a desired fixed-point representation. For example, the desired fixed-point representation may include signed 8-bit data, unsigned 8-bit data, signed 16-bit data, or another representation of the like. Similarly, the output scaling factor and weight scaling factor are representative of scales for quantizing floating-point output values and floating-point weights respectively. In an implementation, scale process 600 outputs fixed-point input values, fixed-point output values, and fixed-point weights based on the input scaling factors, output scaling factors, and weight scaling factors.

After execution of scale process 600, the processing circuitry determines if a maximum number of calibration iterations has been reached (step 505). The number of calibration iterations describes the number of times PTQ process 500 has been executed, without execution of step 506. In an implementation, the maximum number of calibration iterations is equal to 25. Thus, at the 25^{th} calibration iteration, the processing circuitry will determine that the maximum number of calibrations has been reached and proceeds to embed the ANN with the last set of fixed-point weights produced by scale process 600 (step 506).

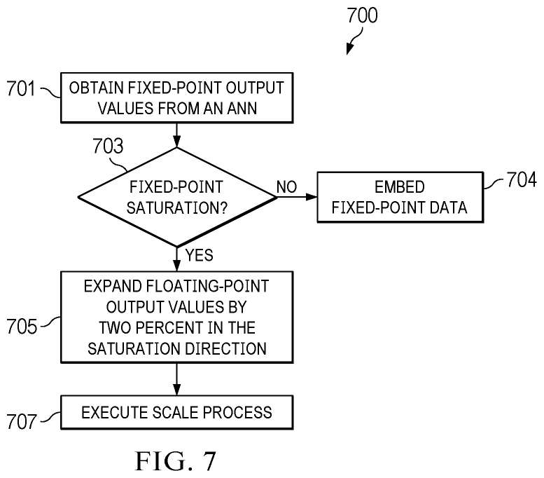

Alternatively, prior to the 25^{th} calibration iteration, the processing circuitry will determine that the maximum number of calibration iterations has not been reached and proceeds to execute a saturation process (step 507). The saturation process executed by the processing circuitry determines if the saturation level of the fixed-point output values produced by the ANN satisfies a saturation threshold. For example, the processing circuitry may execute saturation process 700, later discussed with reference to FIG. 7.

In an implementation, to determine the saturation level, saturation process 700 examines the number of fixed-point output values represented by an extreme of the allowable fixed-point range. For example, when the extremes of the allowable fixed-point range are equal to −127 and +128, the processing circuitry examines the number of values represented by −127 and the number of values represented by +128. If the number of fixed-point output values represented by one of the extremes is greater than 1%, then the processing circuitry expands the range of the floating-point output values based on the direction of the saturation and returns to step 503. Alternatively, if the number of values represented by an extreme of the fixed-point range is less than or equal to 1%, then the processing circuitry proceeds to step 506.

FIG. 6 illustrates scale process 600 in an implementation. Scale process 600 is representative of a process for quantizing the floating-point weights of a neural network (e.g., scale logic 305). For the purposes of explanation, scale process 600 is representative of the process employed by PTQ process 500 for determining the input scaling factors, output scaling factors, and weight scaling factors for quantizing the floating-point data of the ANN. It should be noted that scale process 600 determines scaling factors for each layer of the ANN, but for the purposes of explanation, scale process 600 will be explained within the context of a singular layer.

To begin, the processing circuitry determines the desired data type for representing fixed-point data (step 601). For example, if an associated hardware accelerator performs computations with signed 8-bit data, then the desired data type is representative of signed 8-bit data. Next, the processing circuitry computes the input scaling factor and the output scaling factor based on the floating-point input values and floating-point output values of the ANN (step 603). The input and output scaling factors are representative of scales for quantizing respective floating-point input and output values.

In an implementation, to compute the input and output scaling factors, the processing circuitry first determines the total number of fixed-point values allowed to represent fixed-point data. For example, if the associated hardware accelerator performs operations with signed 8-bit data (i.e., −128 to 127), then the total number of values allowed to represent fixed-point data (e.g., input data, output data, or weight data) is equal to 256. Next, the processing circuitry determines a range of floating-point input values, and a range of floating-point output values. For example, the processing circuitry may execute the following equations:

$${X}_{RANGEfloat} = {X}_{MAXfloat} - {X}_{MINfloat} \qquad ( 1 )$$

$${Y}_{RANGEfloat} = {Y}_{MAXfloat} - {Y}_{MINfloat} \qquad ( 2 )$$

Such that in Equation (1), X_{RANGEfloat} represents the floating-point input range, X_{MAXfloat} represents the maximum floating-point input value, and X_{MINfloat} represents the minimum floating-point input value, and such that in Equation (2) Y_{RANGEfloat} represents the floating-point output range, Y_{MAXfloat} represents the maximum floating-point output value, and Y_{MINfloat} represents the minimum floating-point output value.

Next, to determine the input and output scaling factors, the processing circuitry divides the allowable number of fixed-point values by the respective floating-point range. For example, the processing circuitry may execute the following equations:

$${s}_{X} = \frac{allowable \# of fixed point values}{{X}_{range}} \qquad ( 3 )$$

$${s}_{Y} = \frac{allowable \# of fixed point values}{{Y}_{range}} \qquad ( 4 )$$

Such that in Equation (3), s_{X} represents the input scaling factor and X_{range} represents the range of floating-point input values, and such that in Equation (4), s_{Y} represents the output scaling factor and Y_{range} represents the range of floating-point output values.

In an implementation, the processing circuitry also computes the zero-points for the floating-point input values and the floating-point output values. To determine the zero-points, the processing circuitry first determines the maximum fixed-point value allowed to represent floating-point data. For example, if the desired data type is representative of signed 8-bit data, then the maximum fixed-point value allowed to represent floating-point data is equal to 127. Next, to determine the input and output zero-points, the processing circuitry may execute the following equations:

$${z}_{X} = max fixed point value - ( {X}_{MAXfloat} * {s}_{X} ) \qquad ( 5 )$$

$${z}_{Y} = max fixed point value - ( {Y}_{MAXfloat} * {s}_{Y} ) \qquad ( 6 )$$

Such that in Equation (5), z_{X} represents the input zero-point, X_{MAXfloat} represents the maximum floating-point input value, and s_{X} represents the input scaling factor, and such that in Equation (6) z_{Y} represents the output zero-point, Y_{MAXfloat} represents the maximum floating-point output value, and s_{Y} represents the output scaling factor.

Next, the processing circuitry computes the weight scaling factor for the floating-point weights of the ANN (step 605). In an implementation, to calculate the weight scaling factor, the processing circuitry divides the allowable number of fixed-point values by the absolute maximum floating-point weight value. Thus, the weight scaling factor may be determined with the following equation:

$${s}_{w} = \frac{allowable \# of fixed point values}{\vert {W}_{min / max} \vert} \qquad ( 7 )$$

Such that in Equation (7), s_{W} represents the weight scaling factor and |W_{min/max}| represents the absolute maximum floating-point weight value.

After calculating the scaling factors for the floating-point input values, output values, and weights, the processing circuitry approximates a scale ratio based on a hardware scale ratio utilized by the associated fixed-point hardware (step 607). For example, at runtime, the ANN may offload various multiply-and-accumulate (MAC) operations to a hardware accelerator. For example, such MAC operations may include convolution operations, inner product operations, matrix multiplication operations, or other operations of the like. While the hardware accelerator performs fixed-point computations, the hardware accelerator may require a hardware scale ratio to scale the output of the computations back to the desired bit-depth. In an implementation, to approximate the scale ratio, the processing circuitry executes the following equation:

$$\frac{{s}_{Y}}{{s}_{X} * {s}_{W}} = \frac{{HWA}_{scale}}{{2}^{{HWA}_{shift}}} \qquad ( 8 )$$

Such that in Equation (8), s_{Y} represents the output scaling factor, s_{X} represents the input scaling factor, s_{W} represents the weight scaling factor, HWA_{scale} represents the hardware scaling factor, and HWA_{shift} represents the hardware shifting factor. Furthermore, it should be noted that the ratio of

$$\frac{{s}_{Y}}{{s}_{X} * {s}_{W}}$$

is representative of the scale ratio, while the ratio of HWA_{scale}/2^{HWA}^{_{shift}} is representative of the hardware scale ratio.

Next, the processing circuitry determines if the error in approximating the scale ratio is below an error threshold (step 609). In an implementation, to determine the amount of error between the scale ratio and the hardware scale ratio, the processing circuitry examines a difference between the scale ratio and the hardware scale ratio. If the difference between the scale ratio and the hardware scale ratio is below the error threshold amount, then the processing circuitry quantizes the floating-point weights with the weight scaling factor (step 611). Alternatively, if the difference between the scale ratio and the hardware scale ratio is above the error threshold amount, then the processing circuitry adjusts the weight scaling factor accordingly (step 610).

In an implementation, to adjust the weight scaling factor, the processing circuitry first computes the ideal weight scaling factor based on the hardware scale ratio. For example, the processing circuitry may execute the following equation:

$${{s}_{W}}^{′} = \frac{{s}_{Y} * {2}^{{HWA}_{shift}}}{{s}_{X} * {HWA}_{scale}} \qquad ( 9 )$$

Such that in Equation (9), s_{W}′ represents the ideal weight scaling factor, s_{Y} represents the output scaling factor, HWA_{shift} represents the hardware shifting factor, s_{X} represents the input scaling factor, and HWA_{scale} represents the hardware scaling factor.

Next, the processing circuitry determines if the difference between the ideal weight scaling factor and the weight scaling factor is below 2%. If the difference between the ideal weight scaling factor and the weight scaling factor is below 2%, then the processing circuitry replaces the weight scaling factor with the ideal weight scaling factor. Alternatively, if the difference between the ideal weight scaling factor and the weight scaling factor is greater than or equal to 2%, then the processing circuitry determines whether the weight scaling factor should be increased by 2% or decreased by 2%. In an implementation, to determine whether to increase or decrease the weight scaling factor, the processing circuitry computes the difference between the ideal weight scaling factor and the weight scaling factor. If the difference between the ideal weight scaling factor and the weight scaling factor is greater than zero, then the processing circuitry increases the weight scaling factor by a factor of 2%. Alternatively, if the difference between the ideal weight scaling factor and the weight scaling factor is less than or equal to zero, then the processing circuitry decreases the weight scaling factor by a factor of 2%.

After adjusting the weight scaling factor, the processing circuitry quantizes the floating-point weights based on the adjusted weight scaling factor (step 611). Next, the processing circuitry calculates a hardware bias term based on the weight scaling factor (step 613). The hardware bias term describes a value utilized by the associated hardware accelerator to perform MAC operations. In an implementation, to calculate the hardware bias term the processing circuitry utilizes the following equation:

$$B 1 = {B}^{′} - ( {W}^{′} * {z}_{X} ) + ( {z}_{Y} * \frac{{s}_{Y}}{{s}_{X} * {s}_{W}} ) \qquad ( 10 )$$

Such that in Equation (10), B1 represents the hardware bias term, B′ represents the quantized bias term, W′ represents the fixed-point weights, z_{X} represents the input zero-point, z_{Y} represents the output zero-point, and

$$\frac{{s}_{Y}}{{s}_{X} * {s}_{W}}$$

represents the scale ratio. It should be noted that the quantized bias term is a known value.

Next the processing circuitry determines if the number of bits used to represent the hardware bias term is greater than the number of bits allotted by an associated accumulator (step 615). For example, if the associated accumulator performs computations with 32-bit data, then the number of bits allowed to represent the hardware bias term is equal to 30-bits. If the number of bits used to represent the hardware bias term is greater than the allotted amount, then then the processing circuitry reduces the number of bits which represent the hardware bias term by a factor of one (step 617). In an implementation, the processing circuitry divides the weight scaling factor by two to reduce the number of bits used to represent the hardware bias term. Advantageously, reducing the number of hardware bias bits prevents accumulator overflow error. Next, the processing circuitry returns to step 607 to ensure the adjusted weight scaling factor satisfies the hardware requirements of the associated hardware accelerator. The processing circuitry iteratively performs steps 607 through 617 until the number of bits used to represent the hardware bias term is less than or equal to the allotted amount.

Once the number of bits used to represent the hardware bias term is less than or equal to the allotted amount, the processing circuitry embeds the fixed-point weights into the ANN (step 616). Next, in the context of PTQ process 500, the processing circuitry determines if the maximum number of calibration iterations has been reached (step 505). When the maximum number of calibrations has not been reached, the processing circuitry proceeds to execute saturation process 700 (step 507).

FIG. 7 illustrates saturation process 700 in an implementation. Saturation process 700 is representative of a process for determining if the saturation level of the fixed-point output values (produced by an ANN) represents an acceptable saturation. For example, saturation process 700 may be representative of saturation logic 307 of FIG. 3. For the purposes of explanation, saturation process 700 represents the process employed by PTQ process 500 for determining the saturation level of the fixed-point output values produced by the ANN.

To begin, the processing circuitry obtains fixed-point output values from the ANN (step 701). In an implementation, after the processing circuitry embeds the fixed-point weights into the layers of the ANN, the processing circuitry provides fixed-point input values to the ANN. For example, the processing circuitry may utilize the input scaling factor and input zero-point, generated by scale process 600, to quantize the floating-point input values to fixed-point input values, which are then provided to the ANN. Alternatively, the ANN may receive fixed-point input values from an external source such as a memory configured to store fixed-point input data. In response to receiving the necessary fixed-point data, the ANN produces fixed-point output values which are obtained by the processing circuitry.

Next, the processing circuitry determines if a saturation level of the fixed-point output values represents an acceptable saturation (step 703). The saturation level describes the number of fixed-point output values represented by an extreme of the allowable fixed-point range. For example, when the extremes of the allowable fixed-point range are equal to −127 and +128, the processing circuitry examines the number of values represented by −127 and the number of values represented by +128.

If the processing circuitry determines that the number of fixed-point output values represented by one of the extremes is equal to or less than 1%, then the processing circuitry embeds the current fixed-point weights into the layers of the ANN (step 704). In the context of PTQ process 500, after the processing circuitry determines that the saturation level of the fixed-point output values represents the acceptable saturation, the processing circuitry executes step 506.

Alternatively, if the processing circuitry determines that the number of fixed-point output values represented by one of the extremes is greater than 1%, then the processing circuitry expands the range of floating-point output values by 2% in the direction of the saturation (step 705). In an implementation, to expand the range of floating-point output values, the processing circuitry first identifies the minimum fixed-point output value and the maximum fixed-point output value produced by the ANN. Next, the processing circuitry converts the minimum and maximum fixed-point output values to floating-point numbers based on the derived output scaling factor and output zero-point of scale process 600. For example, the processing circuitry may execute the following equations:

$${Y}_{MINfloat} = \frac{min fixed point value - {z}_{Y}}{{s}_{Y}} \qquad ( 1 )$$

$${Y}_{MAXfloat} = \frac{max fixed point value - {z}_{Y}}{{s}_{Y}} \qquad ( 2 )$$

Such that in Equation (1), Y_{MINfloat} represents the minimum floating-point output value, min fixed point value represents the minimum value allowed by the fixed-point range (e.g., −128), z_{Y} represents the output zero-point, and s_{Y} represents the output scaling factor, and such that in Equation (2) Y_{MAXfloat} represents the maximum floating-point output value, max fixed point value represents the maximum value allowed by the fixed-point range (e.g., +127), z_{Y} represents the output zero-point, and s_{Y} represents the output scaling factor.

Next, the processing circuitry determines the direction of the saturation. For example, the processing circuitry may determine which extreme the fixed-point output values were saturated to. If the fixed-point output values were saturated toward the low-end of the allowable fixed-point range, then the processing circuitry expands the minimum floating-point output value of Equation (1) by 2%. Alternatively, if the fixed-point output values were saturated toward the high-end of the allowable fixed-point range, then the processing circuitry expands the maximum floating-point output value of Equation (2) by 2%.

After updating the fixed-point output range, the processing circuitry returns to scale process 600 to recompute the output scaling factors and weight scaling factors based on the updated fixed-point output range (step 707). In an implementation, the processing circuitry iteratively performs scale process 600 and saturation process 700 until the saturation level of the fixed-point output values represents the acceptable saturation. In another implementation, the processing circuitry iteratively performs scale process 600 and saturation process 700 until the maximum number of calibration iteration has been reached.

Experimental results related to the disclosed technology demonstrate an improvement in accuracy for neural networks employed via fixed-point hardware. For example, in one experiment, neural networks which were quantized with the proposed method displayed an increase of 16.17% in accuracy, as compared to neural networks which were quantized with the previous method for performing post training quantization.

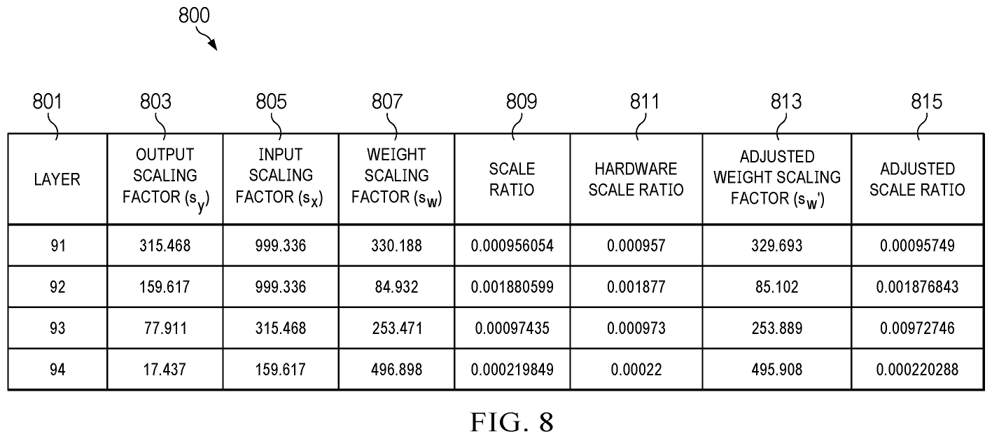

FIG. 8 illustrates results table 800 in an implementation. Results table 800 is representative of a table which depicts the results for adjusting the weight scaling factor in step 610 of scale process 600. Results table 800 includes layer column 801, output scaling factor column 803, input scaling factor column 805, weight scaling factor column 807, scale ratio column 809, hardware scale ratio column 811, adjusted weight scaling factor column 813, and adjusted scale ratio column 815.

Layer column 801 stores data for the 91^{st}, 92^{nd}, 93^{rd}, and 94^{th} layers of the ANN. Output scaling factor column 803 stores the output scaling factors for the respective layers of the ANN. For example, the output scaling factor for the 91^{st} layer equals 315.468. Similarly, input scaling factor column 805 and weight scaling factor column 807 store the input scaling factors and weight scaling factors for the respective layers of the ANN. Scale ratio column 809 stores the various scale ratios for the layers of the ANN, while hardware scale ratio column 811 stores the various hardware scale ratios. For example, the scale ratio for the 93^{rd} layer equals 0.00097435, while the hardware scale ratio equals 0.000973. Adjusted weight scaling factor column 813 stores the adjusted weight scaling factors for the respective layers, and adjusted scale ratio column 815 stores the adjusted scale ratios for the respective layers.

As stated above (in reference to FIG. 6), when adjusting the weight scaling factor, the goal of the processing circuitry is to minimize the difference between the scale ratio and the hardware scale ratio. In an implementation, the processing circuitry adjusts the weight scaling factor so that the difference between the scale ratio and the hardware scale ratio is less than or equal to 1%. For example, for the 92^{nd} layer of the ANN, the processing circuitry adjusts the weight scaling factor to cause the difference between the scale ratio and the hardware scale ratio to reduce from 1.00192% down to 0.99991%.

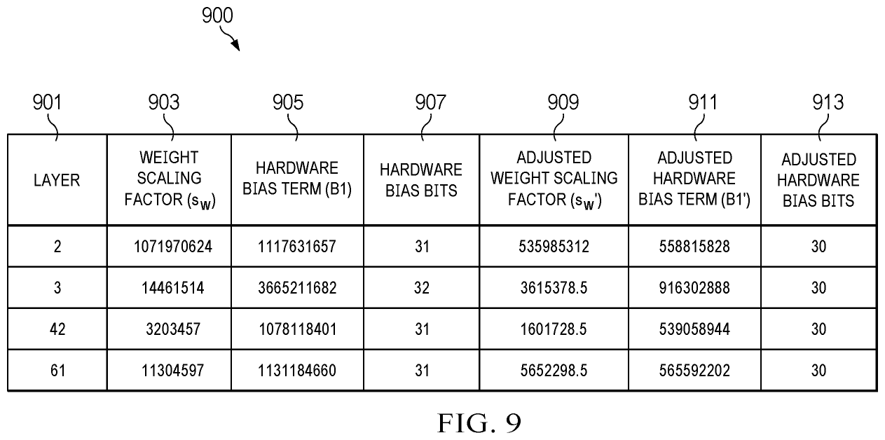

FIG. 9 illustrates results table 900 in an implementation. Results table 900 is representative of table which depicts the results for reducing the number of bits which represent the hardware bias term in step 617 of scale process 600. Results table 900 includes layer column 901, weight scaling factor column 903, hardware bias term column 905, hardware bias bits column 907, adjusted weight scaling factor column 909, adjusted hardware bias term column 911, and adjusted hardware bias bits column 913.

Layer column 901 stores data for the 2^{nd}, 3^{rd}, 42^{nd}, and 61^{st} layers of the ANN. Weight scaling factor column 903 stores the weight scaling factors for the respective layers of the ANN. For example, the weight scaling factor for the 2^{nd} layer of the ANN equals 1071970624. Hardware bias term column 905 stores the hardware bias terms for the respective layers of the ANN, while hardware bias bits column 907 stores the number of bits used to represent the respective hardware bias terms. For example, the hardware bias term for the 3^{rd} layer equals 3665211682, and the number of bits used to represent the bias term equals 32. Adjusted weight scaling factor column 909 stores the adjusted weight scaling factors for the respective layers of the ANN. Adjusted hardware bias term column 911 stores the adjusted hardware bias terms for the respective layers of the ANN while adjusted hardware bias bits column 913 stores the number of adjusted hardware bias term bits.

As stated above (in reference to FIG. 6), when reducing the number of bits which represent the hardware bias term, the goal of the processing circuitry is to prevent accumulator overflow error. For example, if the associated accumulator performs computations with 32-bit data, then the processing circuitry ensures that the hardware bias term is less than or equal to 30-bits long. In an implementation, to reduce the number of bits used to represent the hardware bias term, the processing circuitry divides the respective weight scaling factor by two. For example, for the 42^{nd} layer of the ANN, the processing circuitry divides the weight scaling factor, 3203457, by two, to cause the number of bits which represents the hardware bias term to reduce from 31-bits down to 30-bits.

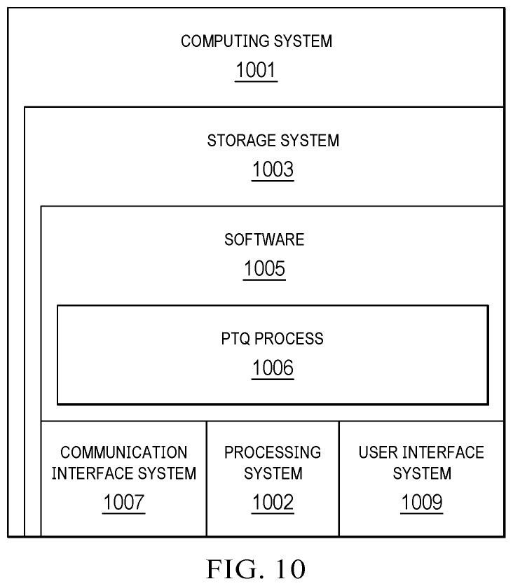

FIG. 10 illustrates computing system 1001 that represents any system or collection of systems in which the various processes, programs, services, and scenarios disclosed herein may be implemented. Computing system 1001 may be implemented as a single apparatus, system, or device or may be implemented in a distributed manner as multiple apparatuses, systems, or devices. Computing system 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements post training quantization (PTQ) process 1006, which is (are) representative of the processes discussed with respect to the preceding Figures, such as PTQ process 103, quantization method 200, quantization logic 303, or PTQ process 500. When executed by processing system 1002, software 1005 directs processing system 1002 to operate as described herein for at least the various processes, operational scenarios, and sequences discussed in the foregoing implementations. Computing system 1001 may optionally include additional devices, features, or functionality not discussed for purposes of brevity.

Referring still to FIG. 10, processing system 1002 comprises a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 comprises any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including PTQ process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing process as described herein for identifying scaling factors. The computing system 1001 may be coupled to one or more sensors and configured to receive input from the one or more sensors (e.g., a camera, radar, lidar, microphone, etc.). The sensor input(s) may form the basis for the input data in PTQ process 1006.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing system 1001 is representative) overall from a general-purpose computing system into a special-purpose computing system customized to support the execution of inference models in an optimized manner. Encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of such productivity applications, they apply as well to other contexts such as gaming applications, virtual and augmented reality applications, business applications, and other types of software applications. Likewise, the concepts apply not just to electronic documents, but to other types of content such as in-game electronic content, virtual and augmented content, databases, language/text, and audio and video content.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A system comprising:
a memory; and
a processor coupled to the memory and configured to:
a) obtain fixed-point output values from a layer of an artificial neural network (ANN), wherein the layer includes fixed-point weights determined based on floating-point weights, and a weight scaling factor determined based on an output scaling factor;
b) convert the fixed-point output values to floating-point output values based on the output scaling factor;
c) expand a range of floating-point output values; and
d) calculate a new output scaling factor based on the expanded range of floating-point output values; and
e) store the new output scaling factor to the memory.

2. The system of claim 1 wherein before the processor converts the fixed-point output values to floating-point output values based on the output scaling factor in step (b), the processor is further configured to determine whether a saturation level of the fixed-point output values comprises an acceptable saturation.

3. The system of claim 2 wherein to determine that the saturation level comprises the acceptable saturation, the processor is further configured to accept the fixed-point weights and refrain from performing steps (b) through (e).

4. The system of claim 2 wherein to determine that the saturation level does not comprise the acceptable saturation, the processor is further configured to proceed with steps (b) through (e).

5. The system of claim 4 wherein after the processor stores the new output scaling factor to the memory in step (e), the processor is further configured to:
f) calculate a new weight scaling factor based on the new output scaling factor;
g) update the fixed-point weights based on the new weight scaling factor; and
h) return to step (a).

6. The system of claim 5 wherein to calculate the new weight scaling factor in step (f), the processor is further configured to:
calculate an ideal weight scaling factor based on a hardware scale, wherein the hardware scale is representative of a ratio of a hardware scaling factor to a hardware shifting factor;
determine a difference between the weight scaling factor and the ideal weight scaling factor; and
determine the new weight scaling factor based on the difference between the weight scaling factor and the ideal weight scaling factor.

7. The system of claim 1 wherein to obtain the fixed-point output values in step (a) the processor is further configured to input fixed-point input values to the ANN, configured with the fixed-point weights, to produce the fixed-point output values.

8. The system of claim 1 wherein before the processor obtains the fixed-point output values in step (a), the processor is further configured to determine the fixed-point weights, and wherein to determine the fixed-point weights, the processor is further configured to scale the floating-point weights based on the weight scaling factor.

9. The system of claim 8 wherein the processor is further configured to determine the weight scaling factor, and wherein to determine the weight scaling factor the processor is further configured to:
input floating-point input values to the ANN configured with the floating-point weights to obtain initial floating-point output values;
calculate an input scaling factor based on the floating-point input values;
calculate the output scaling factor based on the initial floating-point output values;
calculate the weight scaling factor based on the floating-point weights; and
adjust the weight scaling factor based on an allowable number of hardware bias term bits.

10. A method comprising:
a) obtaining fixed-point output values from a layer of an artificial neural network (ANN), wherein the layer includes fixed-point weights determined based on floating-point weights, and a weight scaling factor determined based on an output scaling factor;
b) converting the fixed-point output values to floating-point output values based on the output scaling factor;
c) expanding a range of floating-point output values; and
d) calculating a new output scaling factor based on the expanded range of floating-point output values.

11. The method of claim 10 further comprising, before converting the fixed-point output values to the floating-point output values based on the output scaling factor in step (b), determining whether a saturation level of the fixed-point output values comprises an acceptable saturation.

12. The method of claim 11 further comprising:
in response to determining that the saturation level comprises the acceptable saturation, accepting the fixed-point weights and refraining from performing steps (b) through (d); and
in response to determining that the saturation level does not comprise the acceptable saturation, proceeding with steps (b) through (d).

13. The method of claim 10 further comprising, after calculating the new output scaling factor in step (d):
e) calculating a new weight scaling factor based on the new output scaling factor;
f) updating the fixed-point weights based on the new weight scaling factor; and
g) returning to step (a).

14. The method of claim 13 wherein calculating the new weight scaling factor in step (e) comprises:
calculating an ideal weight scaling factor based on a hardware scale, wherein the hardware scale is representative of a ratio of a hardware scaling factor to a hardware shifting factor;
determining a difference between the weight scaling factor and the ideal weight scaling factor; and
determining the new weight scaling factor based on the difference between the weight scaling factor and the ideal weight scaling factor.

15. The method of claim 10 wherein obtaining the fixed-point output values in step (a) comprises inputting fixed-point input values to the ANN, configured with the fixed-point weights, to produce the fixed-point output values.

16. The method of claim 10 further comprising, before obtaining the fixed-point output values in step (a), determining the fixed-point weights, wherein determining the fixed-point weights comprises scaling the floating-point weights based on the weight scaling factor.

17. The method of claim 16 further comprising determining the weight scaling factor wherein determining the weight scaling factor comprises:
inputting floating-point input values to the ANN configured with the floating-point weights to obtain initial floating-point output values;
calculating an input scaling factor based on the floating-point input values;
calculating the output scaling factor based on the initial floating-point output values;
calculating the weight scaling factor based on the floating-point weights; and
adjusting the weight scaling factor based on an allowable number of hardware bias term bits.

18. The method of claim 17 wherein calculating the new output scaling factor in step (d) comprises:
determining an allowable number of fixed-point output values; and
dividing the allowable number of fixed-point output values by the expanded range of floating-point output values.

19. One or more computer-readable storage media having program instructions stored thereon that, when executed by one or more processors, direct a computing apparatus to at least:
a) obtain fixed-point output values from a layer of an artificial neural network (ANN), wherein the layer includes fixed-point weights determined based on floating-point weights, and a weight scaling factor determined based on an output scaling factor;
b) convert the fixed-point output values to floating-point output values based on the output scaling factor;
c) expand a range of floating-point output values; and
d) calculate a new output scaling factor based on the expanded range of floating-point output values.

20. Processing circuitry coupled with stored instructions for implementing a method, wherein the instructions, when executed by the processing circuitry, carry out steps comprising:
a) obtaining fixed-point output values from a layer of an artificial neural network (ANN), wherein the layer includes fixed-point weights determined based on floating-point weights, and a weight scaling factor determined based on an output scaling factor;
b) converting the fixed-point output values to floating-point output values based on the output scaling factor;
c) expanding a range of floating-point output values; and
d) calculating a new output scaling factor based on the expanded range of floating-point output values.
